(19) United States
(12) Patent Application Publication
(10) Pub. No.: US 2007/0130446 A1
(43) Pub. Date: Jun. 7, 2007

(54) Processor apparatus including specific signal processor core capable of dynamically scheduling tasks and its task control method

(75) Inventor: Tetsuya Minakami, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/607,888

(22) Filed: Dec. 4, 2006

(30) Foreign Application Priority Data
Dec. 5, 2005 (JP) 2005-351012

(51) Int. Cl. G06F 15/00

(52) U.S. Cl. 712/34

(57) ABSTRACT

In a processor apparatus, at least one general purpose central processing unit loads object codes of requested newly-dispatched tasks to a memory. At least one specific signal processing unit core downloads the object codes of the newly-dispatched tasks from the memory to dynamically schedule generation and extinction of the newly-dispatched tasks and schedules operations of currently-executed tasks in accordance with instructions from the general purpose central processing unit.

### BACKGROUND OF THE INVENTION

1. Field of the Invention

The present invention relates to a processor apparatus including at least one general purpose central processing unit (CPU) core and at least one digital signal processing unit core, and its task control method.

2. Description of the Related Art

Recently, a mobile phone is constructed by a baseband processor apparatus formed by a one-chip integrated circuit and an application processor apparatus formed by a one-chip integrated circuit, which will be combined into a single processor apparatus formed by a one-chip integrated circuit.

A prior art application processor formed by a one-chip apparatus is constructed by one or more general purpose central processing unit (CPU) cores and one or more specific signal processing unit cores which are so-called digital signal processors (DSP). For example, in an application processor of a mobile phone, the general purpose CPU cores carry out processings such as an mail display processing and Java (registered trademark) processing, while the specific signal processor core carries out processings (tasks) such as data compression (JPEGenc/MPG4enc) of camera images, and data expansion (MPEG4dec) of television images.

In a prior art processor apparatus (see JP-7-287702 A), a general purpose CPU processor core and at least one specific signal processing unit core (DSP) are provided. The general purpose CPU core loads the object codes of all possible tasks to a memory in advance. Then, the specific signal processing unit core downloads all the above-mentioned object codes thereto from the memory in advance. When a newly-dispatched task is requested by the general purpose CPU core, one of the object codes corresponding to the newly-dispatched tasks is carried out by one of the specific signal processing units.

### SUMMARY OF THE INVENTION

In the above-described prior art processor apparatus, if an additional task whose object code is not downloaded to the specific signal processing unit cores, it is impossible to carry out such a task. In addition, a plurality of specific signal processing unit cores which are able to simultaneously operate would increase the manufacturing cost and the power consumption.

Note that JP-5-204828 discloses a processor apparatus where a direct memory access (DMA) is provided between a general purpose CPU core and a digital signal processing unit core (DSP). As a result, tasks requested by the general purpose CPU core to the digital signal processing unit core (DSP) are limited within the capability thereof.

According to the present invention, in a processor apparatus, at least one general purpose central processing unit loads object codes of requested newly-dispatched tasks to a memory. At least one specific signal processing unit core downloads the object codes of the newly-dispatched tasks from the memory to dynamically schedule generation and extinction of the newly-dispatched tasks and schedules operations of currently-executed tasks in accordance with instructions from the general purpose central processing unit.

### BRIEF DESCRIPTION OF THE DRAWINGS

The present invention will be more clearly understood from the description set forth below, with reference to the accompanying drawings, wherein:

FIG. 1 is a block circuit diagram illustrating a first embodiment of the processor apparatus according to the present invention;

FIGS. 2A, 2B and 2C are flowcharts for explaining the task scheduling operation and task execution of the processor apparatus of FIG. 1;

FIG. 3 is a timing diagram for explaining the task scheduling operation and task execution of the processor apparatus of FIG. 1;

FIG. 4 is a block circuit diagram illustrating a second embodiment of the processor apparatus according to the present invention; and

FIG. 5 is a block circuit diagram illustrating a third embodiment of the processor apparatus according to the present invention.

### DESCRIPTION OF THE PREFERRED EMBODIMENTS

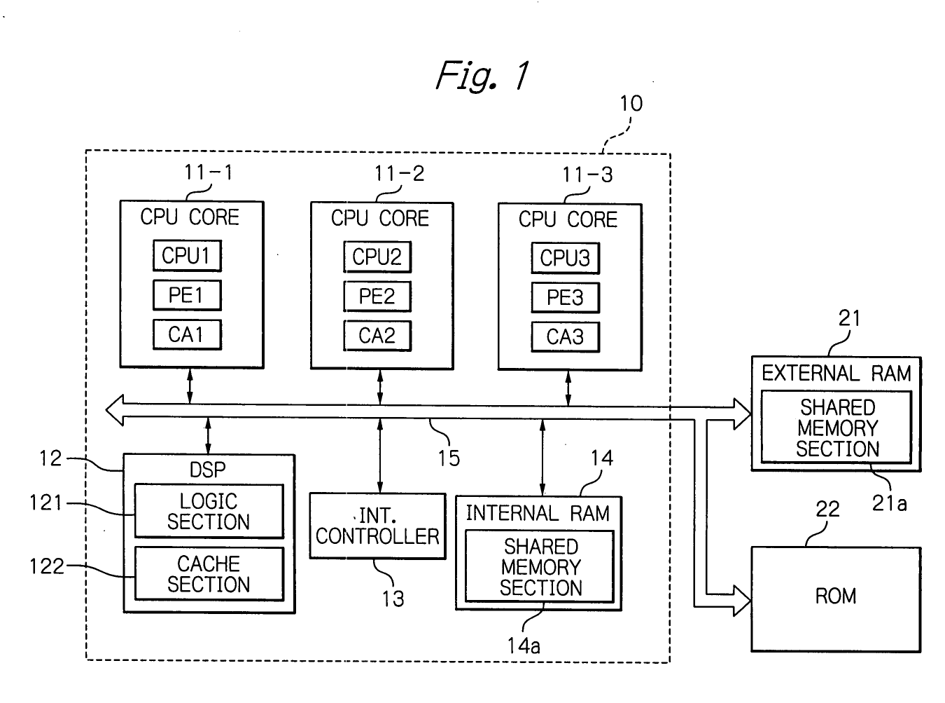

In FIG. 1, which illustrates a first embodiment of the processor apparatus according to the present invention, a processor apparatus 10 is constructed by a one-chip integrated circuit which includes three general purpose central processing unit (CPU) cores 11-1, 11-2 and 11-3, a specific signal processing unit core 12, an interrupt controller 13 and an internal random access memory (RAM) 14 called an on-chip memory, which are connected to each other by an on-chip bus 15. The processor apparatus 10 is also connected via the on-chip bus 15 to an external random access memory (RAM) 21 and an external read only memory (ROM) 22. Note that the ROM 22 may be replaced by a flash memory.

The general purpose CPU cores 11-1, 11-2 and 11-3 are under the control of individual operating systems (OSs). Each of the general purpose CPU cores 11-1, 11-2 and 11-3 is formed by one central processing unit CPU1, CPU2 or CPU3, one processor element PE1, PE2 or PE3 and one cache memory section CM1, CM2 or CM3. Each of the cache memory sections CM1, CM2 and CM3 stores instructions, table data and the like to be executed in the central processing units CPU1, CPU2 and CPU3.

The specific signal processing unit core 13 is a full cache type digital signal processor (DSP) which includes a processor core section (or DSP core logic section) 121 and a cache memory section (or DSP core cache section) 122. In this case, the processor core section 121 serves as a signal processing engine, and the cache memory section 122 stores instructions, table data and the like to be executed in the processor core section 121.

The internal RAM 14 and the external RAM 21 have shared memory sections 14a and 21a, respectively, commonly used for the general purpose CPU cores 11-1, 11-2 and 11-3 and the specific signal processor unit core 12.

When the processor apparatus 10 of FIG. 1 is used as an application processor in a mobile phone, the general purpose CPU cores 11-1, 11-2 and 11-3 carry out processings such as an mail display processing and Java (registered trademark) processing, while the specific signal processor core 12 carries out processings such as data compression (JPEGenc/MPG4enc) of camera images, and data expansion (MPEG4dec) of television images. In FIG. 1, in order to carry out JPEG object codes or MPEG object codes by the specific signal processor core 12, the general purpose CPU cores 11-1, 11-2 and 11-3 load these object codes from the ROM 22 to the shared memory sections 14a and/or 21a of the internal RAM 14 and/or the external RAM 21 in advance.

Since the specific signal processor unit core 12 is a full cache type digital signal processor (DSP) where a sufficiently large instruction cache and a sufficiently large data cache are provided, it is possible to increase processes or tasks in the same way as in a conventional CPU. In this case, this full cache type DSP handles process or task scheduling. Therefore, in the software environment of a mobile phone or a small apparatus including this full cache type DSP, all tasks to be executed are determined in advance and, when the DSP is booted, object codes of all these tasks are transferred from the ROM 22 to the shared memory section 14a and/or the shared memory section 21a of the internal RAM 14 and/or the external RAM 21.

Also, a scheduler of the operating system (OS) of the DSP can dynamically schedule newly-dispatched tasks. That is, the scheduler supervises dynamic generation and extinction of tasks so that newly-dispatched tasks requested from the general purpose CPU cores 11-1, 11-2 and 11-3 are registered in the scheduler, while the operation of currently-executed tasks are scheduled. Note that “dispatch” assigns the operating capability of the processor core section 121 to processes and tasks to be executed.

Instructions such as specific signal processing (task) request commands are transmitted from the general purpose CPU cores 11-1, 11-2 and 11-3 to the specific signal processing unit core 12, thus dynamically scheduling newly-dispatched tasks. Also, instructions such as processing start commands and processing end commands transmitted from the general purpose CPU cores 11-1, 11-2 and 11-3 to the specific signal processing unit core 12 are distributed to the currently-executed tasks.

Generally, one instruction format is formed by a field of a requested instruction content of a command, a field of a source of the command, a field of a destination of result data of the command, and a field showing a priority of the requested instruction content.

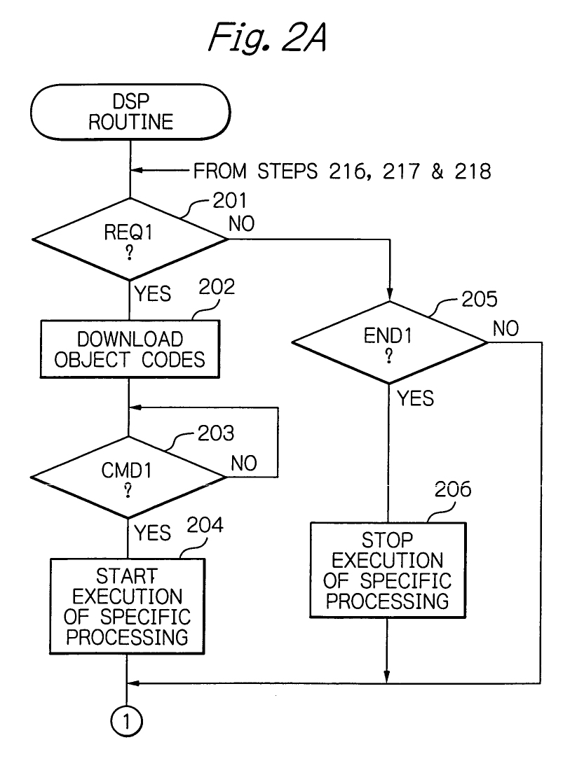

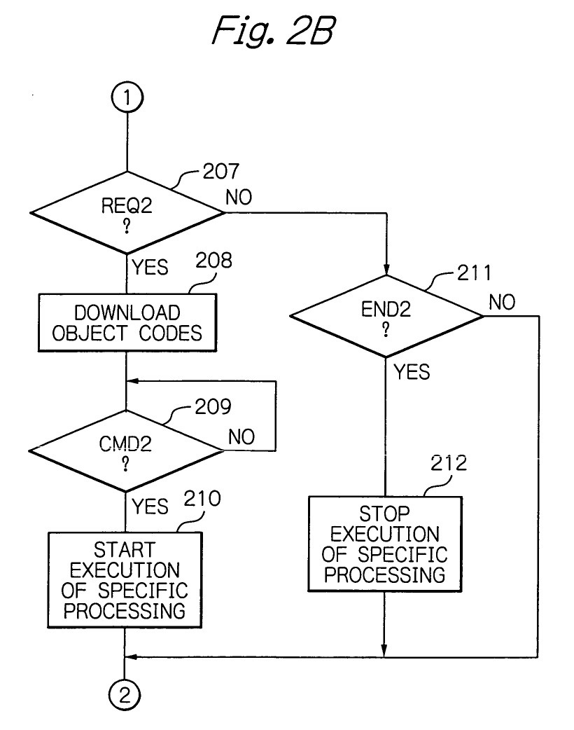

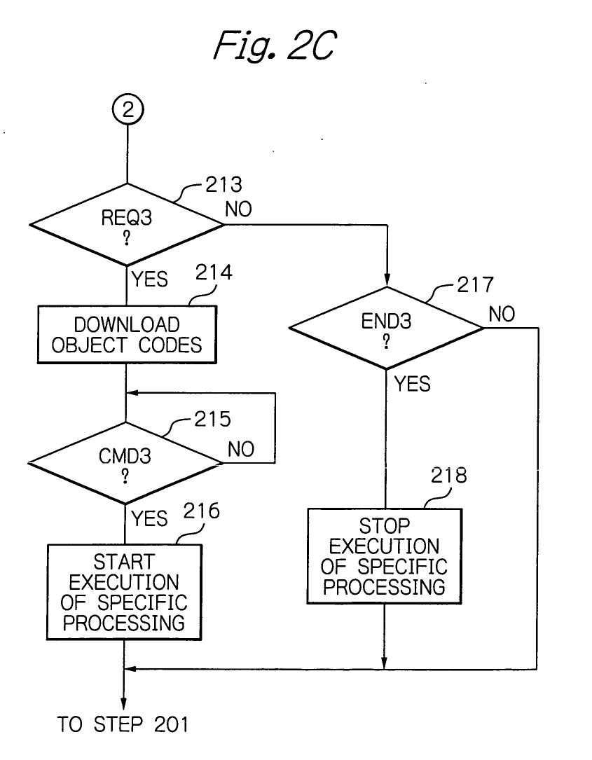

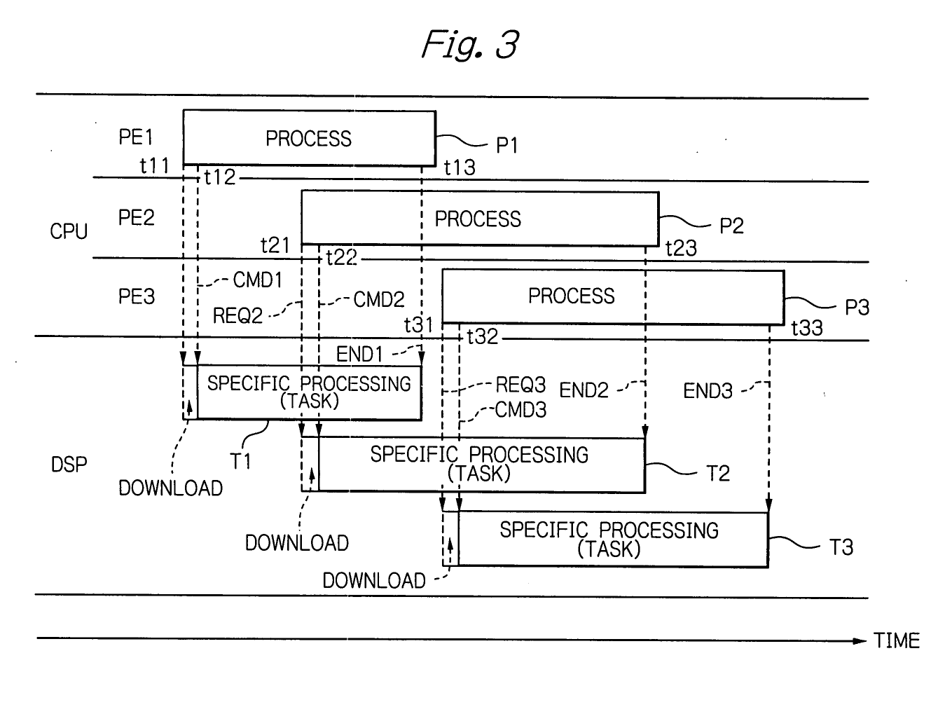

The operation of the processor apparatus of FIG. 1, particularly, the task execution and task scheduling operation of the specific signal processing unit core (DSP) 12 is explained next with reference to FIG. 2A, 2B and 2C and FIG. 3. Here, steps 201 to 206 are used for scheduling and executing a specific signal processing (task) for the general purpose CPU core 11-1 when the general purpose CPU core 11-1 carries out a process P1 shown in FIG. 3, steps 207 to 212 are used for scheduling and executing a specific signal processing (task) for the general purpose CPU core 11-2 when the general purpose CPU core 11-2 carries out a process P2 shown in FIG. 3, and steps 213 to 218 are used for scheduling and executing a specific signal processing (task) for the general purpose CPU core 11-3 when the general purpose CPU core 11-3 carries out a process P3 shown in FIG. 3. Also, the general purpose CPU cores 11-1, 11-2 and 11-3 load object codes of the above-mentioned individual specific signal processings (tasks) from the ROM 22 to the shared memory section 14a and/or 21a of the internal RAM 14 and/or the external RAM 21 in advance.

Steps 201 to 206 are explained below.

First, at step 201, it is determined whether or not the DSP 12 has received a specific signal processing request command REQ1 from the general purpose CPU core 11-1. Only when the DSP 12 has received such a specific signal processing request command REQ1, does the control proceed to step 202. Otherwise, the control proceeds to step 205.

For example, at time t11 of FIG. 3 when the DSP 12 has received the specific signal processing request command REQ1, the control proceeds from step 201 to step 202 which downloads object codes of a specific signal processing (task) T1 for the general purpose CPU core 11-1 from the shared memory section 14a or 21a to the cache memory section 122. Thus, the specific signal processing (task) T1 is dynamically generated in the DSP 12.

Next, at step 203, the DSP 12 waits for a processing start command CMD1 from the general purpose CPU core 11-1 relating to the specific signal processing request command REQ1. Only when the DSP 12 has received such a processing start command CMD1, does the control proceed to step 204 which starts execution of the specific signal processing T1 using the object codes downloaded at step 202.

For example, at time t12 of FIG. 3 when the DSP 12 has received the processing start command CMD1, the control proceeds from step 203 to step 204.

On the other hand, at step 205, it is determined whether or not the DSP 12 has received a processing end command END1 from the general purpose CPU core 11-1 relating to the specific signal processing request command REQ1. Only when the DSP 12 has received such a processing end command END1, does the control proceed to step 206. Otherwise, the control proceeds to step 207.

For example, at time t13 of FIG. 3 when the DSP 12 has received the processing end command END1, the control proceeds from step 205 to step 206 which ends the execution of the specific signal processing T1. Thus, the memory area therefor in the cache memory section 122 is released, so that the specific signal processing (task) T1 is dynamically extinguished.

The control at step 204 or 206 proceeds to step 207.

Note that step 203 can be omitted. In this case, immediately after the object codes of the specific signal processing (task) T1 are downloaded in the cache memory section 122 at step 202, the object codes are carried out at step 204.

Steps 207 to 212 are explained below.

First, at step 207, it is determined whether or not the DSP 12 has received a specific signal processing request command REQ2 from the general purpose CPU core 11-2. Only when the DSP 12 has received such a specific signal processing request command REQ2, does the control proceed to step 208. Otherwise, the control proceeds to step 211.

For example, at time t21 of FIG. 3 when the DSP 12 has received the specific signal processing request command REQ2, the control proceeds from step 207 to step 208 which downloads object codes of a specific signal processing (task) T2 for the general purpose CPU core 11-2 from the shared memory section 14a or 21a to the cache memory section 122. Thus, the specific signal processing (task) T2 is dynamically generated in the DSP 12.

Next, at step 209, the DSP 12 waits for a processing start command CMD2 from the general purpose CPU core 11-2 relating to the specific signal processing request command REQ2. Only when the DSP 12 has received such a processing start command CMD2, does the control proceed to step 210 which starts execution of the specific signal processing T2 using the object codes downloaded at step 208

For example, at time t22 of FIG. 3 when the DSP 12 has received the processing start command CMD2, the control proceeds from step 209 to step 210.

On the other hand, at step 211, it is determined whether or not the DSP 12 has received a processing end command END2 from the general purpose CPU core 11-2 relating to the specific signal processing request command REQ2. Only when the DSP 12 has received such a processing end command END2, does the control proceed to step 212. Otherwise, the control proceeds to step 213.

For example, at time t23 of FIG. 3 when the DSP 12 has received the above-mentioned processing end command END2, the control proceeds from step 211 to step 212 which ends the execution of the specific signal processing T2. Thus, the memory area therefor in the cache memory section 122 is released, so that the specific signal processing (task) T2 is dynamically extinguished.

The control at step 210 or 212 proceeds to step 213.

Note that step 209 can be omitted. In this case, immediately after the object codes of the specific signal processing (task) T2 are downloaded in the cache memory section 122 at step 208, the object codes are carried out at step 210.

Steps 213 to 218 are explained below.

First, at step 213, it is determined whether or not the DSP 12 has received a specific signal processing request command REQ3 from the general purpose CPU core 11-3. Only when the DSP 12 has received such a specific signal processing request command REQ1, does the control proceed to step 214. Otherwise, the control proceeds to step 217.

For example, at time t31 of FIG. 3 when the DSP 12 has received the specific signal processing request command REQ3, the control proceeds from step 213 to step 214 which downloads object codes of a specific signal processing (task) T3 for the general purpose CPU core 11-3 from the shared memory section 14a or 21a to the cache memory section 122. Thus, the specific signal processing (task) T3 is dynamically generated in the DSP 12.

Next, at step 214, the DSP 12 waits for a processing start command CMD3 from the general purpose CPU core 11-3 relating to the specific signal processing request command REQ3. Only when the DSP 12 has received such a processing start command CMD3, does the control proceed to step 216 which starts execution of the specific signal processing T3 using the object codes downloaded at step 214.

For example, at time t32 of FIG. 3 when the DSP 12 has received the processing start command CMD3, the control proceeds from step 214 to step 210.

On the other hand, at step 217, it is determined whether or not the DSP 12 has received a processing end command END3 from the general purpose CPU core 11-3 relating to the specific signal processing request command REQ3. Only when the DSP 12 has received such a processing end command END3, does the control proceed to step 218. Otherwise, the control returns to step 201.

For example, at time t33 of FIG. 3 when the DSP 12 has received the processing end command END3, the control proceeds from step 217 to step 218 which ends the execution of the specific signal processing T3. Thus, the memory area therefor in the cache memory section 122 is released, so that the specific signal processing (task) T3 is dynamically extinguished.

The control at step 216 or 218 returns to step 201.

Note that step 215 can be omitted. In this case, immediately after the object codes of the specific signal processing (task) T3 are downloaded in the cache memory section 122 at step 214, the object codes are carried out at step 216.

In FIG. 3, the specific signal processings (tasks) T1 and T2 are parallelly carried out from time t22 to time t13, and also, the specific signal processings (tasks) T2 and T3 are parallelly carried out from time t32 to time t23. In this case, if a performance required for the sum of the specific signal processings (tasks) T1 and T2 and a performance required for the sum of the specific signal processings T2 and T3 are both lower than the limit performance of the DSP 12, even when the amount of processings is dynamically increased, the performance would hardly fluctuate.

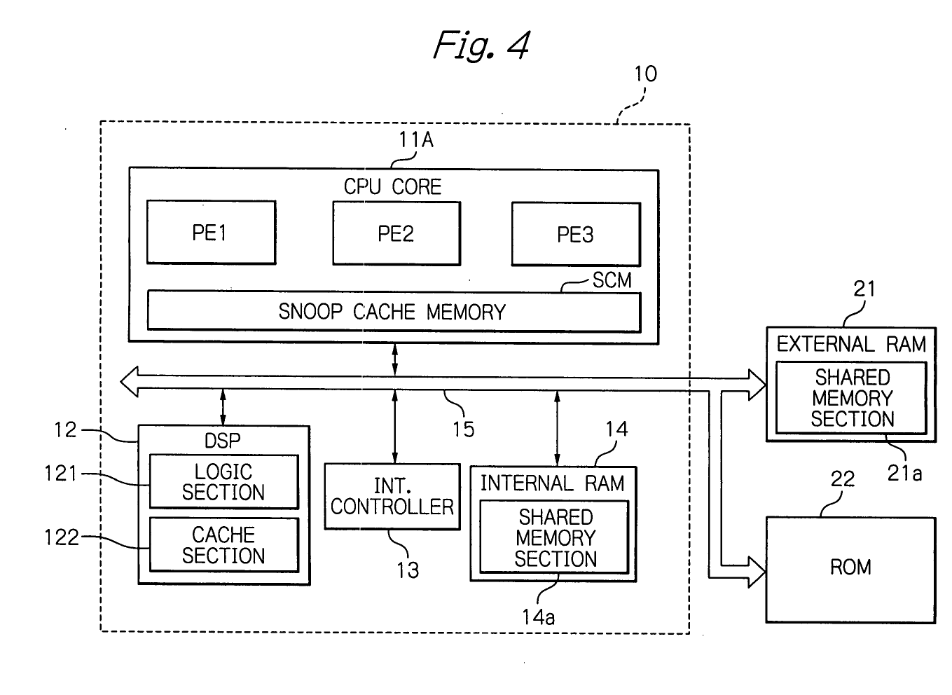

In FIG. 4, which illustrates a second embodiment of the processor apparatus according to the present invention, the general purpose central CPU cores 11-1, 11-2 and 11-3 of FIG. 1 are replaced by a general purpose CPU core 11A which is a symmetrical multiprocessor (SMP) formed by three processor elements PE1, PE2 and PE3 and a snoop cache memory section SCM. The general purpose CPU core 11A is under the control of one operating system (OS). The snoop cache memory section SCM includes cache blocks (not shown) each for one of the processor elements PE1, PE2 and PE3. The memory access on the on-chip bus 15 is monitored by the snoop cache memory section SCM, to keep coherency of data among the cache blocks of the snoop cache memory section SCM.

The task scheduling operation and task execution of the processor apparatus 10 of FIG. 4 are similar to those of the processor apparatus 10 of FIG. 1. In this case, each individual process or thread executed in the general purpose CPU core 11A independent of the PE numbers of the processor elements PE1, PE2 and PE3 generates a specific signal processing request, so that a respective specific signal processing (task) is independently executed.

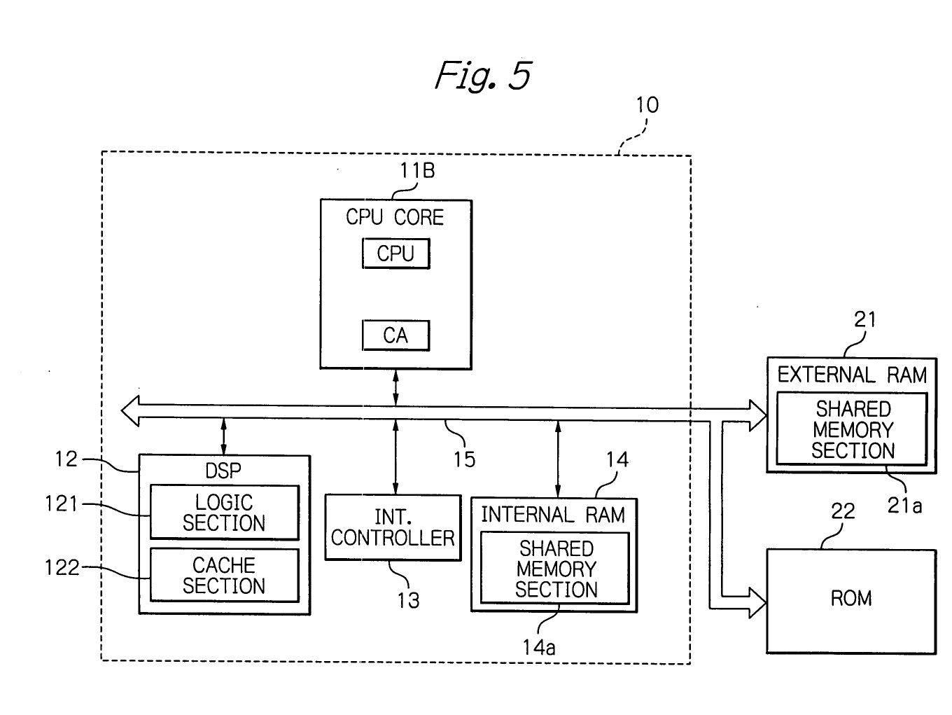

In FIG. 5, which illustrates a third embodiment of the processor apparatus according to the present invention, the general purpose central CPU cores 11-1, 11-2 and 11-3 of FIG. 1 are replaced by a general purpose CPU core 11B which includes a single CPU and a cache memory section CM. The general purpose CPU core 11B is under the control of one operating system (OS).

The task scheduling operation and task execution of the processor apparatus 10 of FIG. 5 are similar to those of the processor apparatus 10 of FIG. 1. In this case, each individual process or thread executed in the general purpose CPU core 11B generates a specific signal processing request, so that a respective specific signal processing (task) is independently executed.

In summary, the features of the present invention are as follows:

1) The general purpose CPU cores 11-1, 11-2, 11-3, 11A and 11B load object codes of newly-dispatched tasks to the DSP 12 from the ROM 22 to the shared memory section 14a and/or 21a of the internal RAM 14 and/or the external RAM 21.

2) The DSP 12 has a sufficiently large instruction cache and a sufficiently large data cache to carry out the dispatched tasks.

3) The operation system (OS) of the DSP 12 supervises the dynamic generation and extinction of specific signal processings (tasks) in accordance with specific signal processing request commands and processing end commands from the general purpose CPU cores 11-1, 11-2, 11-3, 11A and 11B. That is, newly-dispatched specific signal processings (tasks) are scheduled. Also, the operation of other specific signal processings (tasks) currently executed are scheduled.

4) Instructions are transferred from the general purpose CPU cores 11-1, 11-2, 11-3, 11A and 11B to the DSP 12, so that the instructions are distributed to the currently-executed specific signal processings (tasks). In this case, one instruction format is formed by a field of a requested instruction content of a command, a field of a source of the command, a field of a destination of result data of the command, and a field showing a priority of the requested instruction content, which enables a suitable data transmission and reception between the general purpose CPU cores 11-1, 11-2, 11-3, 11A and 11B and the DSP 12.

As a result, the DSP 12 performs specific signal processings (tasks) in accordance with a dynamic request from a source, i.e., one of the general purpose CPU cores 11-1, 11-2, 11-3, 11A and 11B, so that the result data can be transmitted to the destination, i.e., the one of the general purpose CPU cores 11-1, 11-2, 11-3, 11A and 11B. In this case, since data as well as the object codes of a plurality of currently-executed specific signal processings (tasks) are downloaded to the cache memory section 122 of the DSP 12 where the mishit rate is assumed to be small, the fluctuation of the performance would hardly fluctuate, even if the number of currently-executed specific signal processings (tasks) is increased.

Also, since downloading, execution and ending of a specific signal processing (task) are occasionally carried out by a specific signal processing request command, a processing start command and a processing end command, respectively from a general purpose CPU core, an unexpected specific signal processing (task) can be easily carried out. In this case, the available memory amount can be reduced so that the power consumption can be reduced.

In the above-described embodiments, although only one DSP as a specific signal processing unit is provided, one or more DSPs can be provided as such specific signal processing units.

The processor apparatus according to the present invention can be applied to not only an application processor of a mobile phone, but also a baseband processor of a mobile phone and a single processor comprised by an application processor and a baseband processor of a mobile phone.

1. A processor apparatus comprising:
at least one general purpose central processing unit adapted to load object codes of requested newly-dispatched tasks to a memory;
at least one specific signal processing unit core adapted to download the object codes of said newly-dispatched tasks from said memory to dynamically schedule generation and extinction of said newly-dispatched tasks and schedule operations of currently-executed tasks in accordance with instructions from said general purpose central processing unit.

2. The processor apparatus as set forth in claim 1, wherein a format of each said instructions is formed by a field of a requested instruction content of a command, a field of a source of the command, a field of a destination of result data of the command, and a field showing a priority of the requested instruction content of said command.

3. The processor apparatus as set forth in claim 1, wherein when said command is a specific signal processing request, said specific signal processing unit core downloads the object codes of a respective one of said newly-dispatched tasks.

4. The processor apparatus as set forth in claim 2, wherein when said command is a processing start command, said specific signal processing unit core starts execution of a respective one of said newly-dispatched tasks.

5. The processor apparatus as set forth in claim 2, wherein when said command is a processing end command, said specific signal processing unit core ends execution of a respective one of said newly-dispatched tasks.

6. The processor apparatus as set forth in claim 1, wherein when said command is a specific signal processing request, said specific signal processing unit core downloads the object codes of a respective one of said newly-dispatched tasks, and subsequently, starts execution of the respective one of said newly-dispatched tasks.

7. The processor apparatus as set forth in claim 1, wherein said general purpose central processing unit comprises a plurality of general purpose processing unit cores, each of said general purpose central processing unit cores including:
a central processing unit;
a processor element; and
a cache memory section.

8. The processor apparatus as set forth in claim 1, wherein said general purpose central processing unit comprises a symmetrical multiprocessor, said symmetrical multiprocessor including:
a plurality of processor elements; and
a snoop cache memory section.

9. The processor apparatus as set forth in claim 1, wherein said general purpose central processing unit comprises a single general purpose processing unit core, said general purpose central processing unit core including:
a central processing unit; and
a cache memory section.

10. The processor apparatus as set forth in claim 1, wherein said memory comprises a shared memory section of an internal memory.

11. The processor apparatus as set forth in claim 1, wherein said memory comprises a shared memory section of an external memory.

12. A task control method for a processor apparatus including at least one general purpose central processing unit core and at least one specific signal processing unit core, comprising:
downloading object codes of a task to said specific signal processing unit core in accordance with a respective one of specific signal processing request signals corresponding to processes of said general purpose central processing unit core;
starting execution of said task by said specific signal processing unit core; and
ending the execution of said task when said specific signal processing unit core has received a respective one of processing end signals relating to said specific signal processing request signals from said general purpose central processing unit core.

13. The method as set forth in claim 12, wherein said specific signal processing unit core starts said execution of said task in response to a receipt of a respective one of processing start signals relating to said specific signal processing request signals from said general purpose central processing unit core.

14. A task control method for a processor apparatus including a plurality of processor elements and a specific signal processing unit core, comprising:
executing a first task requested from a first process of a first one of said processor elements by said specific signal processor core;
executing a second task requested from a second process of a second one of said processor elements by said specific signal processor core, said first and second tasks being parallelly executed; and
ending execution of said first task to release a memory for a third process of a third one of said processor elements.
